(19) United States
(12) Patent Application Publication
(10) Pub. No.: US 2008/0171538 A1
(43) Pub. Date: Jul. 17, 2008

(54) Mobile Communications System

(75) Inventors: Kosuke Naito, Tokyo (JP); Tadashi Ogami, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Tokyo (JP)

(21) Appl. No.: 10/599,309

(22) PCT Filed: Mar. 25, 2005
(86) PCT No.: PCT/JP2005/006415

§ 371 Date: Mar. 5, 2007

(30) Foreign Application Priority Data
Mar. 25, 2004 (JP) 2004-089003

(51) Int. Cl. H04Q 7/38

(52) U.S. Cl. 455/414.1

(57) ABSTRACT

A mobile communication system in which a specific user occupies and uses a base station is provided.

A base station allows a downlink signal to include not only a base station ID number indicating the base station but also an identification signal for specific use indicating that the base station is for specific use and sends the downlink signal. The terminal includes a memory (25) that stores a list of base station ID numbers of an accessible base station or an inaccessible base station every identification signal for specific use, and searches whether or not the base station ID number in the received downlink signal is in the list of base station ID number every detected identification signal for specific use in the memory when the identification signal for specific use detected from the downlink signal is ON and performs communication with the base station only when the access is OK.

### TECHNICAL FIELD

The present invention relates to a mobile communication system.

### BACKGROUND ART

A base station in a mobile communication system has become compact and light. Further, the base station is examined as an in-structure base station to be installed in a structure, in particular, at each home.

FIG. 1 shows a mobile communication system according to a related art, in which a large covered area (or, service area) 100 having an existing base station 101 includes an in-structure base station 201 having a small cover area (or, service area) 200, and the covered area 100 of the existing base station 101 includes the covered area 200 of the in-structure base station 201.

Upon using the base station as the in-structure base station 201 as mentioned above, the in-structure base station 201 is used only by a specific user (user of the in-structure base station 201 is assumed), it is required that a general user that unexpectedly enters the covered area 200 of the in-structure base station 201 cannot use resources. However, the current mobile communication system does not correspond to access limit varied depending on users or base stations as the unit basis.

Therefore, if many general users except for the specific user who originally wants to use the in-structure base station 201 are within the covered area 200 of the in-structure base station 201, the general users use the resources of the base station and the service quality to the specific user deteriorates.

That is, even at an in-structure base station or a home base station, (in order to use the existing terminal), a downlink common channel should send data compatible with that of the existing base station. Originally, even a terminal that is not allowed to use the resource of the in-structure base station and the home base station can access and use the resource. If the identification is devised on a network, the request of positional registration or of calling from the terminal cannot be prevented.

Japanese Patent No. 2953113 discloses a method by which each mobile station stores an identification number of an accessible base station, the stored identification number is compared with a base station ID number in a downlink common channel, and the access is permitted only when both the identification numbers match each other. It is not practical that all base station ID numbers that are permitted (or are not permitted) with respect to the access are stored and one base station ID number is compared with all ones every time.

### DISCLOSURE OF INVENTION

### Problems to be Solved by the Invention

According to the present invention, in order to solve the problems, there is provided a mobile communication system in which a general user cannot access a base station for specific use and a specific user thus can occupy and use the base station for specific use.

That is, it is an object of the present invention to prevent the use of resources of a base station from a general user other than a specific user and the deterioration in service quality to the specific user as the using result in an in-structure base station or home base station that is assumed to provide services to the specific user.

### Means for Solving the Problems

According to the present invention, a mobile communication system comprises a base station and a terminal,

the base station allows a downlink signal to include not only a base station ID number indicating the base station but also an identification signal for specific use indicating that the base station is for specific use and sends the downlink signal, and

the terminal comprises a memory that stores a list of base station ID numbers of an accessible base station or an inaccessible base station every identification signal for specific use, and searches whether or not the base station ID number in the received downlink signal is in the list of base station ID number every the detected identification signal for specific use in the memory when the identification signal for specific use detected from the downlink signal is ON and performs communication with the base station only when the access is OK.

Further, according to the present invention, a mobile communication system comprises a base station and a terminal,

the base station allows a downlink signal to include not only a base station identification number indicating the base station but also an identification signal for specific use indicating the base station is for specific use, and sends the downlink signal,

in the mobile communication system, the terminal comprises a memory that stores a list of base station identification number of an accessible base station or an inaccessible base station every identification signal for specific use, and searches whether or not the base station ID number in the received downlink signal is in the list of base station ID number every detected identification signal for specific use in the memory when the identification signal for specific use detected from the downlink signal is ON and performs communication with the base station only when the access is OK, and

the base station comprises an identification signal generation unit that generates the identification signal for specific use and a modulation unit (13) that allows the generated identification signal for specific use and the base station identification signal to be included in the downlink signal and sends the downlink signal.

Furthermore, according to the present invention, a mobile communication system comprises a base station and a terminal, and

the base station allows a downlink signal to include not only a base station identification number indicating the base station but also an identification signal for specific use indicating the base station is for specific use, and sends the downlink signal,

in the mobile communication system, the terminal comprises

a memory that stores a list of base station identification number of an accessible base station or an inaccessible base station every identification signal for specific use, and

a determination unit that searches whether or not the base station ID number in the received downlink signal is in the list of base station ID number every detected identification signal for specific use in the memory when the identification signal for specific use detected from the downlink signal is ON and performs communication with the base station only when the access is OK.

### ADVANTAGES

According to the present invention, a general user cannot access the base station for specific use. As a consequence, it is possible to obtain a mobile communication system in which the specific user can occupy and use the base station.

That is, according to the present invention, it is possible to prevent the use of resources of a base station from a general user other than a specific user and the deterioration in service quality to the specific user as the using result in an in-structure base station or home base station that is assumed to provide services to the specific user.

Further, according to the present invention, a relatively easy method can accomplish the access limit varied depending on the terminal and the base station only between the terminal and the base station, which can be conventionally realized only at the core of a mobile communication network, e.g., a management center of user information.

### BRIEF DESCRIPTION OF THE DRAWINGS

FIG. 1 is a diagram for illustrating a mobile communication system according to a related art.

FIG. 2 is a diagram for illustrating a mobile communication system according to the present invention.

FIG. 3 is a block diagram showing one mobile communication system base station (base station) in a mobile communication system according to the first embodiment of the present invention.

FIG. 4 is a block diagram showing the one mobile communication terminal (terminal) in the mobile communication system according to the first embodiment.

FIG. 5 is a time chart for illustrating operation of the terminal shown in FIG. 4.

FIG. 6 is a block diagram showing another mobile communication system base station (base station) according to the present invention.

FIG. 7 is a block diagram showing a mobile communication system according to the second embodiment of the present invention.

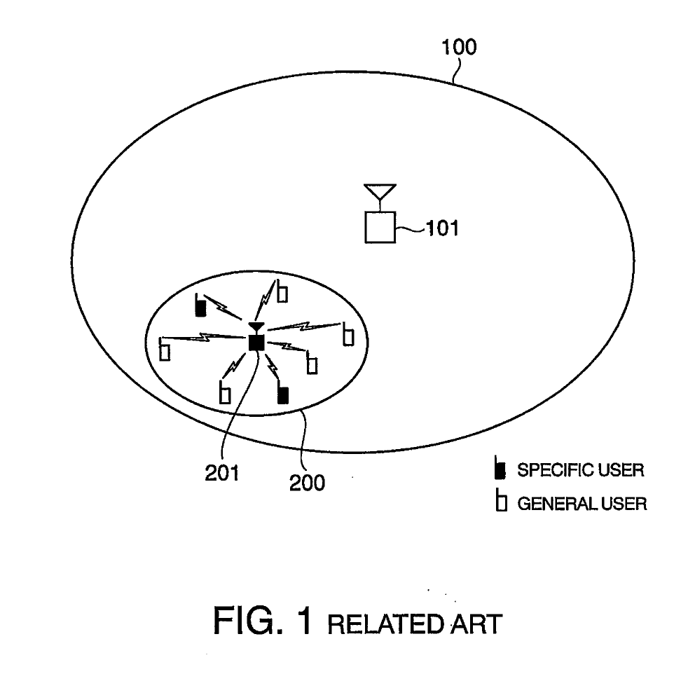

### BEST MODE FOR CARRYING OUT THE INVENTION

Next, a description is given of embodiments of the present invention with reference to the drawings.

According to the present invention, not only a base station ID number indicating a base station but also an identification signal for specific use indicating a base station for specific use (for in-structure, home, or hot spot) is added to a downlink common channel for sending data from the base station.

A terminal stores a list of base station ID number of an accessible (or inaccessible) base station every identification signal for specific use. Upon detecting the received identification signal for specific use from the downlink common channel, the received base station ID number in the downlink common channel is searched from the list of base station ID numbers of the detected identification signal for specific use and communication is performed only when the access of the base station ID number is permitted.

The list of base station ID number for each identification signals for specific use is stored in a memory such as an SIM (Subscriber Identify Module). Alternatively, it may be written by a shop or may be rewritten during the communication.

Thus, only the specific user that registers in advance the list of base station ID number for each identification signal for specific use can access the base station. It is thus possible to prevent that another general user uses resources of the base station.

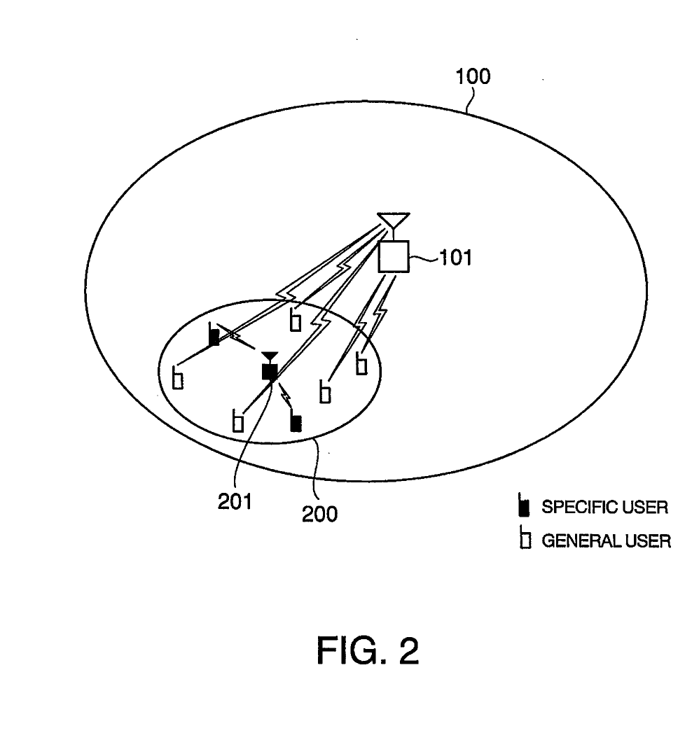

First, a mobile communication system according to the present invention will be described with reference to FIG. 2. Similarly, the mobile communication system shown in FIG. 2 has such an arrangement that a large covered area (or, service area) 100 of an existing base station 101 includes an in-structure base station 201 of a small covered area (or, service area) 200 and the covered area 100 of the existing base station 101 includes the covered area 200 of the in-structure base station 201.

The present invention provides the mobile communication system in which a specific user (user of the in-structure base station 201) can occupy and use the base station 201 by preventing the access of general users to the base station 201 for specific use, as shown in FIG. 2. That is, according to the present invention, the resource assigned to the specific user is assured by preventing the access of general users to the in-structure base station 201.

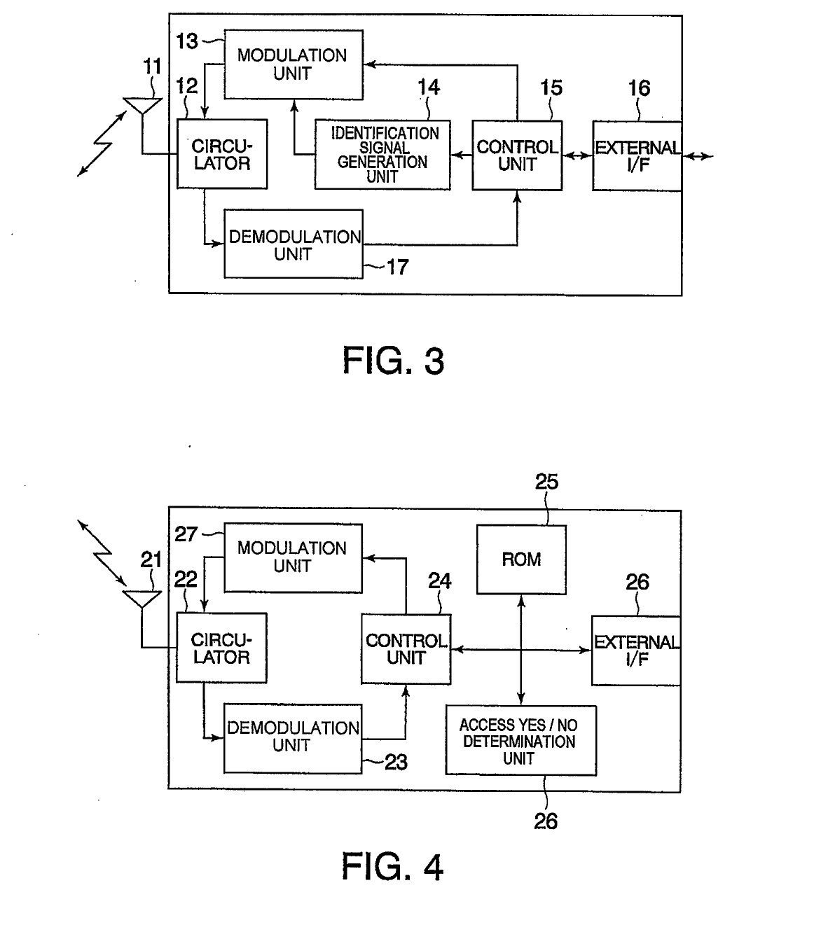

FIG. 3 shows the structure of a mobile communication system base station (hereinafter, simply referred to as a base station) in a mobile communication system according to the first embodiment of the present invention.

Referring to FIG. 3, an identification signal generation unit 14 generates an identification signal for specific use indicating the base station for specific user (in-structure, home, or hot spot), and sends the identification signal to a modulation unit 13. The identification signal for specific use is generated in accordance with an instruction from a control unit 15 or an external instruction via an external 1/F (Interface) 16.

It is noted that the identification signal generation unit 14 can partly form the control unit 15.

The modulation unit 13 multiplexes and modulates the identification signal for specific use as well as another control signal or user data sent from the control unit 15 and the base-station identification signal of the base station, and sends the multiplexed and modulated signals via a circulator 12 and an antenna 11. A demodulation unit 17 has a function for demodulating a signal sent from the terminal.

The antenna 11, the circulator 12, the modulation unit 13, the demodulation unit 17, and the external 1/F 16 are well known by those in the art and do not directly relate to the present invention. Accordingly, a specific description thereof is omitted.

FIG. 4 shows the structure of a mobile communication terminal (hereinafter, referred to as a terminal) in the mobile communication system according to the first embodiment.

Referring to FIG. 4, a signal sent from the base station is captured to a demodulation unit 23 via an antenna 21 and a circulator 22, and the identification signal for specific use is received. The identification signal for specific use is sent from a control unit 24 to an access YES/NO determination unit 26, and is determined on the basis of the list of base station ID number for each identification signal for specific use, stored in a ROM (Read-Only Memory) 25, whether or not the access to the base station is permitted. If it is determined that the access is permitted, an up sending signal is generated by a modulation unit 27 and is sent via the circulator 22 and the antenna 21.

It is noted that the access YES/NO determination unit 26 can partly form the control unit 24.

The antenna 21, the circulator 22, the modulation unit 27, the demodulation unit 23, and the terminal 1/F 28 are well known by those in the art and do not directly relate to the present invention. Thus, a specific description thereof is omitted.

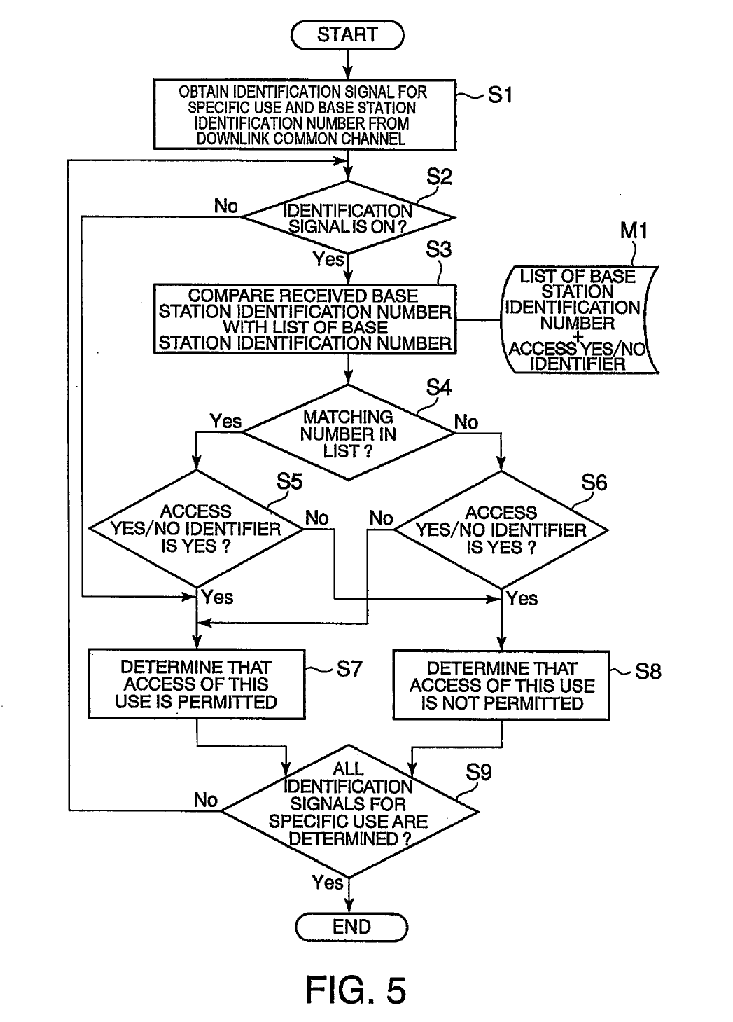

Next, a detailed description will be given of the operation of the access YES/NO determination unit 26 in the terminal shown in FIG. 4 with reference to a flowchart shown in FIG. 5.

First, the demodulation unit obtains the identification signal for specific use and the base station ID number from a downlink reception signal (S1). Subsequently, it is determined whether or not the identification signal for specific use corresponding to the specific use, indicated by the received identification signal for specific use, is ON (S2). If it is determined that the identification signal for specific use is OFF, the access is not limited and it is therefore determined that the access is permitted (S7).

If the identification signal for specific use is ON, the received base station ID number is searched in the list of base station ID number, stored in a memory 25 (M1 in FIG. 5) of the terminal (S3). It is noted that the list can be “null”. If the list is “null”, the matching number does not always exist.

If the matching number exists (S4), an access YES/NO identifier stored in the memory 25 (M1 in FIG. 5) is checked (S5). If the access YES/NO identifier indicates YES, it is determined that the access is permitted (S7). If not so, it is determined that the access is not permitted (S8).

Further, if the matching number does not exist in S4, similarly, the access YES/NO identifier (M1) is checked (S6). If the access is permitted in S6, on the contrary to S5, it is determined that the access is not permitted (S8). If not so, it is determined that the access is permitted (S7).

If the identification signal for specific use that is not subjected to the processing exists, the processing returns to S2 and the processing is performed (S9). After all processing is performed, the sequence ends.

It is noted that the operation in the flowchart is performed every terminal connection to the base station.

Next, a description is given of determination as whether or not the identification signal for specific use is generated. As described in the structure example, the control unit 15 in the base station directly determines whether or not the identification signal for specific use is generated. Alternatively, an upper layer of the control unit on a mobile communication network determines it and notifies the result to the base station. Further, an instruction from the upper layer and processing of the base station control unit can be combined.

In the determination as whether or not the identification signal for specific use is generated, a service provider can be uniquely determined depending on the setting place or the setting object. Further, information such as the resource using situation or time zone of the base station is added and can be sequentially switched.

Even in the case of the base station for specific use, the identification signal for specific use is OFF and the access of general users is permitted until a resource using rate is over one predetermined value.

At an in-structure base station for office, in the evening, night, and holiday, the identification signal for specific use is set to OFF. At the home base station, at a time zone of daytime when a person is not absent at home, the identification signal for specific use is set to OFF.

By combining the two manners, a threshold of the resource using rate is varied depending on application or time zone.

When the resource is tight at the general base station having an overlapped area of the base station for specific use, the identification signal for specific use is set to OFF.

According to a first advantage of according to the first embodiment, at the in-structure base station or home base station installed for specific user, only the specific user can access the resource. Therefore, it is prevented that another user uses the resource.

According to a second advantage of the first embodiment, the terminal can determine whether or not the access is permitted only from the downlink common channel. Therefore, the identification is not necessary on the upper layer on the network and the access can be limited variably depending on the terminal and the base station. Further, this enables the reduction of unnecessary positional registration and of handover frequency. As a consequence, the power consumption of the terminal and the base station can be reduced.

According to a third advantage of the first embodiment, ON/OFF operation of the identification signal for specific use can be controlled. Even at the in-structure base station or home base station for specific user, flexible switching depending on the resource using situation and day of the week and time zone enables efficient use of equipment of the base station and the resource.

Herein, the method according to the first embodiment is compared with the conventional method disclosed in Patent Document 1.

According to the conventional method, the terminal has to store all identification numbers of accessible base stations. In order to cover all base stations of one carrier, few or tens several thousands identification numbers need to be registered. Every area movement, in the worst case, the identification numbers of all the areas need to be compared with the identification numbers of the moved base stations. Further, when the base station is added, the lists of all the terminals need to be written.

On the other hand, with the method according to the first embodiment, only when the identification signal for specific use is ON, the identification number is compared with the list of base station identification numbers. Therefore, any user is not affected by the addition and deletion of an accessible general base station.

For the user that does not the base station for specific use, the list is “null” and the access YES/NO identifier is set to “access YES”. If so, the load of the processing is not caused and the user is not affected when the base station for specific use is added.

It is considered that the number of base station for specific use of one user is sufficiently 10 to 20. Therefore, if the identification number is compared with the list thereof every area movement, the amount of processing is not so large.

Further, when a fast-communicable base station is arranged like a hot spot, the user of the fast communication needs to be able to use any host spots. Even in this case, the user that does not use the fast communication sets the list for use thereof as “null” and also sets the access YES/NO identifier as “access YES”. Further, the user that does not use the fast communication sets the list as “null” and also sets the access YES/NO identifier as “access NO”. As a consequence, the access of many specific users/base stations can be easily limited.

According to the first embodiment, the description has been given of the method for controlling the determination as the generation of the identifications signal for specific use depending on the setting place, setting object, day of the week, and the time zone. For example, the user is not periodically at home and even when he is at home, the resource of the base station does not need to be occupied. Thus, the best control is not necessarily performed. Hereinbelow, a description is given of another mobile communication system base-station corresponding to the above case according to the present invention.

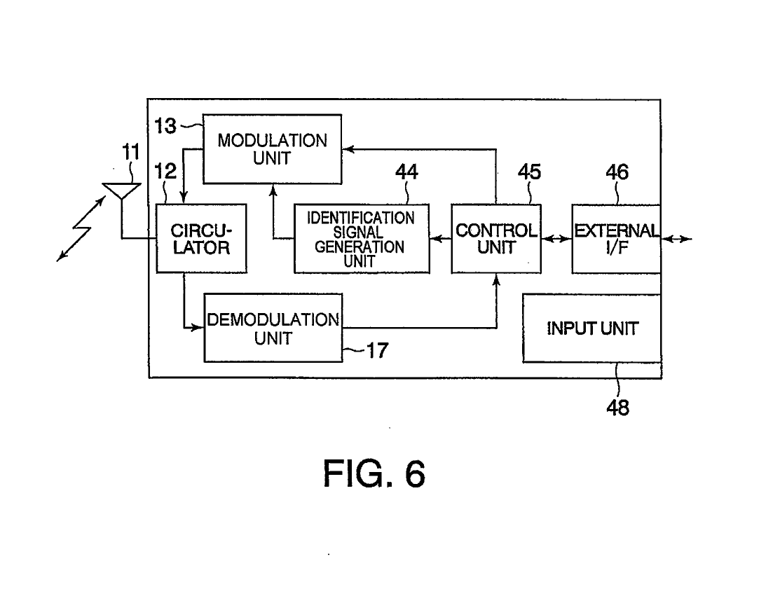

Referring to FIG. 6, the structure of the other mobile communication system base station (hereinafter, referred to as a base station) is shown according to the present invention.

As compared with the base station shown in FIG. 3, the base station shown in FIG. 6 has additionally has an input unit 48. A specific user of the base station inputs whether or not the resource of the base station for specific use is occupied with the input unit and the input result is sent to a control unit 45.

When the control unit 45 determines whether or not an identification signal for specific use is generated, the control unit 45 uses the input result as a determination resource upon generating the identification signal for specific use and sends the result to an identification signal generation unit 44. When a portion other than the control unit 45 in the base station, such as a control unit in the mobile communication network, determines whether or not an identification signal for specific use is generated, the control unit 45 sends an input result via an external 1/F 46 and receives the determination result of generating the externally-determined identification signal for specific use.

Further, as mentioned according to the first embodiment, upon using such a control method for permitting the access of general users when the resource using rate is a predetermined value or less, the input unit 48 can input a resource using rate desired by the specific user, thereby enabling the fine control.

It is noted that the operation of other components is the same as that shown in FIG. 3. Thus, a detailed description thereof is omitted.

Further, on the mobile communication system using the base station shown in FIG. 6, in order to optimally the resource, the specific user at the setting place of the base station needs to frequently set the base station in accordance with the using situation. Only if there are any merits obtained by frequent setting operation, the user can be guided as mentioned above. Hereinbelow, a description is given of the structure of a system for presenting the merit not only to the user but also to a service carrier in this case.

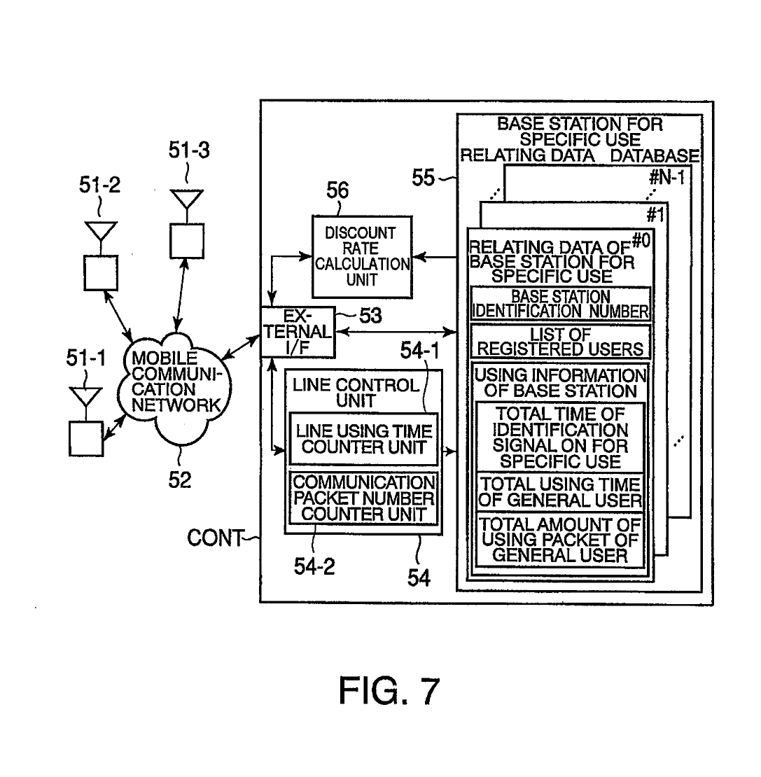

FIG. 7 shows the structure of a mobile communication system according to the second embodiment of the present invention.

Referring to FIG. 7, reference numerals 51-1 to 51-3 denote base stations for specific use having the structure shown in FIG. 6. The base stations periodically sends information indicating whether the identification signal for specific use is ON or OFF to a mobile communication network 52 from the identification signal generation unit 44. The information is sent to a control unit CONT in the mobile communication network 52 and is further sent to a base station relating database 55 (hereinafter, referred to as a database 55) for specific use via an external 1/F 53 thereof.

The database 55 has the following information as databases every base station for specific use.

Base station identification number

List of registered users

Using information of the base station
Total time of identification signal ON for specific use
Total time of using time of general user
Total amount of using packet of general user
   When the information indicating the state of the identification signal for specific use sent from the base station is an identification signal ON, the ON time is accumulated in the database 55 and the “total time of identification signal ON for specific use” of the corresponding base station is updated.

When the user performs line communication or packet communication with the resource at the base station, in a line control unit 54, a counter unit 54-1 of a line using time counts the using time of the line and a counter unit 54-2 of the number of communication packets counts the amount of communication packets. After ending the communication, the line control unit 54 sends the counting number to the database 55. Further, the line control unit 54 simultaneously sends the identification number of the user who calls and the identification number of the base station. When the user moves from one base station to another base station during the communication, a plurality of identification numbers of the base stations that perform the communication are sent.

In the database 55, the sent base station identification number is compared with the base station identification number stored in the database, and it is determined whether or not the communication is performed at the base station for specific use. If it is determined that the communication is not performed at the base station for specific use, the processing for the communication ends.

If it is determined that the communication is performed at the base station for specific use, the identification number of the user that performs the communication is compared with the list of registered users of the base station and it is checked whether or not the user is a specific user of the base station. If matching, that is, it is determined that the user is a specific user of the base station, the processing for the communication ends.

If not matching, that is, it is determined that a general user uses the base station, the sent counted using time and counted number of packets are added to the “total using time of general user” and the “total number of using packets of general user”, respectively.

A base station ID number discount rate calculation unit 56 calculates a charge discount rate for user of the base station on the basis of using information of the base station stored in the database 55. Generally, as the total time of the identification signal ON for specific use is shorter and as the using time and the amount of using packets of general user are larger, the discount rate is larger to discount the charge.

With this structure, the user of the base station for specific uses actively opens the resource of the base station to general users during the time when the user does not use the base station and such a merit that the charge to be paid to the carrier by the user can be suppressed. Further, the carrier can improve the using efficient of the set base station equipment, and can improve the service quality of all users as a result.

Next, preferred embodiments of the present invention will be described with reference to FIGS. 3, 6, and 7.

1) A mobile communication system comprises a base station and a terminal, the base station allows a downlink signal to include not only a base station ID number indicating the base station but also an identification signal for specific use indicating that the base station is for specific use and sends the downlink signal, and

the terminal comprises a memory (25) that stores a list of base station ID numbers of an accessible base station or an inaccessible base station every identification signal for specific use, and searches whether or not the base station ID number in the received downlink signal is in the list of base station ID number every detected identification signal for specific use in the memory when the identification signal for specific use detected from the downlink signal is ON and performs communication with the base station only when the access is OK.

2) In the mobile communication system described in 1), the base station allows the identification signal for specific use to be included in a downlink common channel and sends the signal.

3) The mobile communication system described in 1) further comprises a mobile communication network (52) connected to the base station, and the base station periodically sends information indicating whether or not the identification signal for specific use is sent, and the mobile communication network sends the information to a database (55) for storing the information.

4) In the mobile communication system described in 3), the mobile communication network comprises a discount rate calculation unit (56) that calculates a charge discount rate of a user of the base station on the basis of using information on the base station stored in the database.

5) In the mobile communication system described in 4), the discount rate calculation unit increases the charge discount rate of the user of the base station, as the total time for sending the identification signal for specific use is shorter or as the using time or the amount of using packet of a general user other than the user of the base station is larger.

6) A base station in a mobile communication system, the mobile communication system comprises the base station and a terminal,

the base station allows a downlink signal to include not only a base station identification number indicating the base station but also an identification signal for specific use indicating the base station is for specific use, and sends the downlink signal,

the terminal comprises a memory (52) that stores a list of base station identification number of an accessible base station or an inaccessible base station every identification signal for specific use, and searches whether or not the base station ID number in the received downlink signal is in the list of base station ID number every detected identification signal for specific use in the memory when the identification signal for specific use detected from the downlink signal is ON and performs communication with the base station only when the access is OK, and

the base station comprises an identification signal generation unit (14 or 44) that generates the identification signal for specific use and a modulation unit (13) that allows the generated identification signal for specific use and the base station identification signal to be included in the downlink signal and sends the downlink signal.

7) The base station described in 6) allows the identification signal for specific use to be included in a downlink common channel and sends the signal.

8) The base station described in 6) further comprises an input unit (48) that inputs whether or not a resource of the base station is to be occupied, and the identification signal generation unit generates the identification signal for specific use on the basis of an input result of the input unit indicating that the resource of the base station is to be occupied.

9) A terminal in a mobile communication system, the mobile communication system comprises a base station and the terminal, and the base station allows a downlink signal to include not only a base station identification number indicating the base station but also an identification signal for specific use indicating the base station is for specific use, and sends the downlink signal,

the terminal comprises

a memory (52) that stores a list of base station identification number of an accessible base station or an inaccessible base station every identification signal for specific use, and

a determination unit (26) that searches whether or not the base station ID number in the received downlink signal is in the list of base station ID number every detected identification signal for specific use in the memory when the identification signal for specific use detected from the downlink signal is ON and performs communication with the base station only when the access is OK.

1. A mobile communication system comprising a base station and a terminal,
the base station allowing a downlink signal to include not only a base station ID number indicating the base station but also an identification signal for specific use indicating that the base station is for specific use and sending the downlink signal, and
the terminal comprising a memory that stores a list of base station ID numbers of an accessible base station or an inaccessible base station every identification signal for specific use, and searching whether or not the base station ID number in the received downlink signal is in the list of base station ID number every the detected identification signal for specific use in the memory when the identification signal for specific use detected from the downlink signal is ON and performing communication with the base station only when the access is OK.

2. A mobile communication system according to claim 1, wherein the base station allows the identification signal for specific use to be included in a downlink common channel and sends the signal.

3. A mobile communication system according to claim 1, further comprising a mobile communication network connected to the base station,
wherein the base station periodically sends information indicating whether or not the identification signal for specific use is sent, and
the mobile communication network sends the information to a database for storing the information.

4. A mobile communication system according to claim 3, wherein the mobile communication network comprises a discount rate calculation unit that calculates a charge discount rate of a user of the base station on the basis of using information on the base station stored in the database.

5. A mobile communication system according to claim 4, wherein the discount rate calculation unit increases the charge discount rate of the user of the base station as the total time for sending the identification signal for specific use is short or as the using time or the amount of using packet of a general user other than the user of the base station is larger.

6. A base station in a mobile communication system, the mobile communication system comprising the base station and a terminal,
the base station allowing a downlink signal to include not only a base station identification number indicating the base station but also an identification signal for specific use indicating the base station is for specific use, and sending the downlink signal,
the terminal comprising a memory that stores a list of base station identification number of an accessible base station or an inaccessible base station every the identification signal for specific use, and searching whether or not the base station ID number in the received downlink signal is in the list of base station ID number every the detected identification signal for specific use in the memory when the identification signal for specific use detected from the downlink signal is ON and performing communication with the base station only when the access is OK, and
the base station comprising an identification signal generation unit that generates the identification signal for specific use and a modulation unit that allows the generated identification signal for specific use and the base station identification signal to be included in the downlink signal and sends the downlink signal.

7. A base station according to claim 6, wherein the base station allows the identification signal for specific use to be included in a downlink common channel and sends the signal.

8. A base station according to claim 6, further comprising
an input unit that inputs whether or not a resource of the base station is to be occupied,
wherein the identification signal generation unit generates the identification signal for specific use on the basis of an input result of the input unit indicating that the resource of the base station is to be occupied.

9. A terminal in a mobile communication system, the mobile communication system comprising a base station and the terminal,
the base station allowing a downlink signal to include not only a base station identification number indicating the base station but also an identification signal for specific use indicating the base station is for specific use, and sending the downlink signal,
the terminal comprising:
a memory that stores a list of base station identification number of an accessible base station or an inaccessible base station every identification signal for specific use; and
a determination unit that searches whether or not the base station ID number in the received downlink signal is in the list of base station ID number every the detected identification signal for specific use in the memory when the identification signal for specific use detected from the downlink signal is ON and performs communication with the base station only when the access is OK.
